(19) United States
(12) Patent Application Publication
(10) Pub. No.: US 2021/0042768 A1
(43) Pub. Date: Feb. 11, 2021

(54) SYNTHETIC COHORT DECAY ANALYSIS AND USES THEREOF

(71) Applicant: Gregory Paul DAINES, Alpine, UT (US)

(72) Inventor: Gregory Paul DAINES, Alpine, UT (US)

(21) Appl. No.: 16/988,051

(22) Filed: Aug. 7, 2020

Related U.S. Application Data
(60) Provisional application No. 62/885,063, filed on Aug. 9, 2019.

(51) Int. Cl. G06Q 30/02; G06F 16/23; G06F 16/215; G06F 16/21; G06F 16/2458

(52) U.S. Cl. CPC G06Q 30/0201; G06Q 30/0204; G06F 16/2477; G06F 16/215; G06F 16/213; G06F 16/2365

(57) ABSTRACT

Methods for performing cohort decay analysis include operations of collecting, compiling, and organizing data about members of a group into member input data. The operations may also include determining activity periods for each of the members of the cohort and identifying unique data fields based on the data fields in the collected member input data. The operations may include performing synthetic cohort retention analysis and modeling on the unique data fields and determining at least one localized decay rate of the collected member input data for the unique data fields. The operations may include determining and modeling a decay rate for the collected member input data for the selected unique data field based on one or more localized decay rates. The operations may also include updating the localized decay rate, decay rate, and cohort retention model based on changes, additions, or deletions to the collected member input data.

### FIELD

The embodiments discussed in the present disclosure are related to decay rate analysis.

### BACKGROUND

Entities (e.g., persons, businesses, etc.) may subscribe to a service that may be provided by a service provider (e.g., a gym, Internet service, music service, video service, mobile phone service, etc.). Some subscribers may maintain their subscriptions indefinitely. However, other subscribers may cancel their subscriptions after a particular period of time. Similarly, some entities may subscribe to a certain activity in that the entities may participate in the certain activity (e.g., sports, music, dance, community service, etc.) in a recurring manner. Such subscribers may participate for a certain amount of time and then may cease to participate. The factors that relate to retention of subscribers or conversely decay of subscribers may vary.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, operations may include collecting data about members of a group. The operations may further include separating the group into subgroups called cohorts and organizing the members' data in each of the cohorts into member input data for synthetic cohort retention analysis and modeling. The operations may further include determining activity periods for each of the members of the cohort. Moreover, the operations may further include identifying collected data fields based on the member input data. The operations may further include identifying unique data fields based on the collected data fields. Additionally, the operations may also include deleting or collating the member input data in the collected data fields to identify the unique data fields. The operations may further include selecting one or more of the unique data fields for performing synthetic cohort retention analysis and modeling. Moreover, the operations may further include organizing the collected member input data into cohorts, wherein a cohort is a plurality of members in the group of subscribers of a particular activity that is associated with a shared characteristic associated with a unique data field. The operations may include organizing the cohorts responsive to the selected unique data field or fields based on the each of the individual member's activity periods. The operations may also include determining at least one localized decay rate of the cohort between two or activity periods. The operations may further include determining a decay rate for the cohort for the selected unique data field based on the localized decay rates. The operations may also include modeling the decay rate in a cohort retention model. Additionally, the operations may also include updating the localized decay rate, decay rate, and cohort retention model based on changes, additions, or deletions to the collected member input data.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to determining decay rates based on member input data;

FIG. 2 is a diagram representing an example environment related to modeling decay rates in a cohort retention model;

FIGS. 3A and 3B include a flowchart of an example method of determining decay rates based on member input data and modeling the decay rates in a cohort retention model;

FIG. 4 is a diagram representing an example environment related to determining activity periods for member input data;

FIG. 5 is a flowchart of an example method for determining decay rates for a unique data field based on members' activity periods;

FIG. 6A illustrates an example set of member input data;

FIG. 6B illustrates example unique data fields based on the set of member input data of FIG. 6A;

FIG. 7 illustrates an example process for determining unique data fields by deleting duplicate data fields;

FIG. 8A illustrates an example cohort retention model based on a binary unique data field;

FIG. 8B illustrates an example cohort retention model based on a non-binary unique data field; and

FIG. 9 illustrates an example computing system.

### DESCRIPTION OF EMBODIMENTS

Some embodiments described in the present disclosure relate to methods and systems of performing synthetic cohort retention analysis and modeling.

Users rely on data analysis models to provide a variety of metrics that are indicative of the overall growth or decay of a group of subscribers. However, typical data analysis models do not separate subscribers in a group based on how long the subscribers have been present in the group. Accounting for the temporal relation between subscribers clarifies trends in growth or decay over discrete time periods in the group rather than only the overall growth or decay rate of the group. In the present disclosure, reference to a subscriber may include entities (persons, businesses, etc.) who subscribe to a recurring type service or entities who participate in an activity (sports, music, dance, community service, religion, etc.) in a recurring manner.

The present disclosure relates to analysis of cohort retention of a group of subscribers with respect to activity periods. In the present disclosure, reference to a cohort may include subscribers that are associated with a common characteristic, wherein the characteristic is associated with a data field. Further, a group of subscribers may include any number of cohorts from one to hundreds. Further, a particular subscriber of a particular group of subscribers may be part of one or more than one cohorts of the particular group of subscribers.

Cohort retention analysis may be useful for modeling and analyzing data as a function of discrete activity periods. Traditional cohort analysis methods may separate a group into cohorts to analyze characteristics of interest based on the cohorts. However, traditional cohort analysis methods may be restrictive and/or incapable of analyzing the time-relation of cohorts within a larger group across various subscription parameters. In contrast, the operations described in the present disclosure provide a mechanism for analyzing the time-relation of cohorts in a given group across various subscription parameters, which may improve currently available cohort analysis models and data analysis software programs more generally.

According to one or more embodiments of the present disclosure, the technological field of cohort retention analysis and modeling may be improved by configuring a computing system in a manner in which the computing system is able to perform cohort analysis across a variety of data fields to model the time-relation between cohorts in these varied data fields. Additionally, in some embodiments, the computing system may be configured to perform cohort analysis, based on member input data, for cohorts of varying sizes.

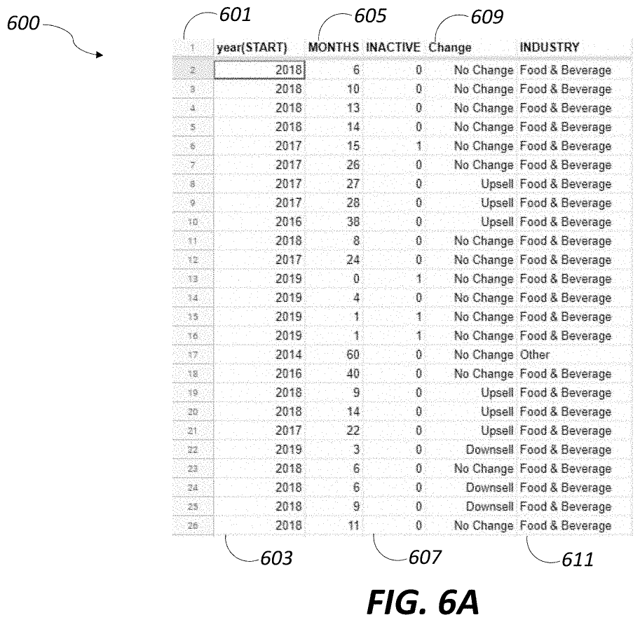

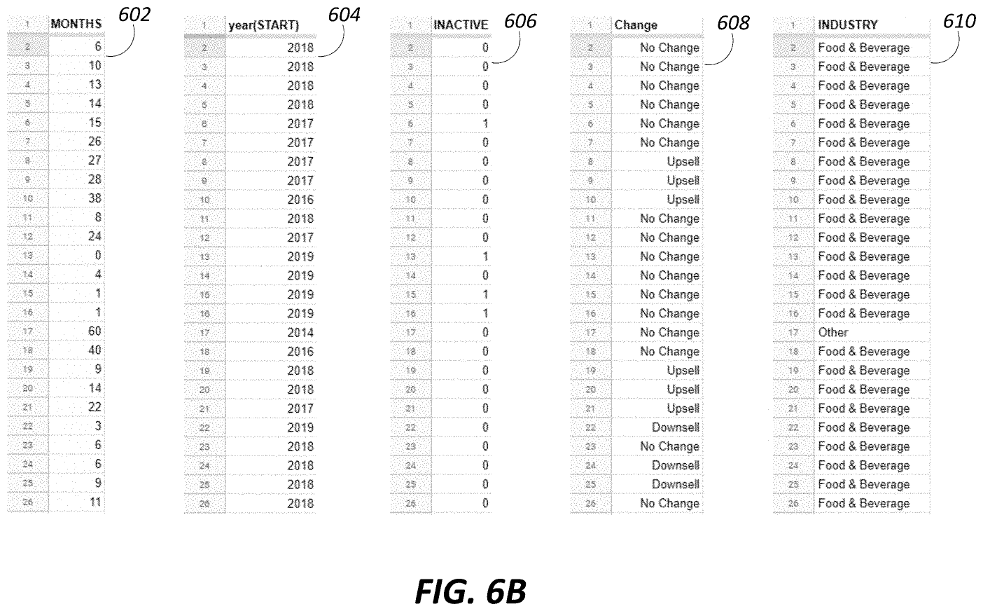

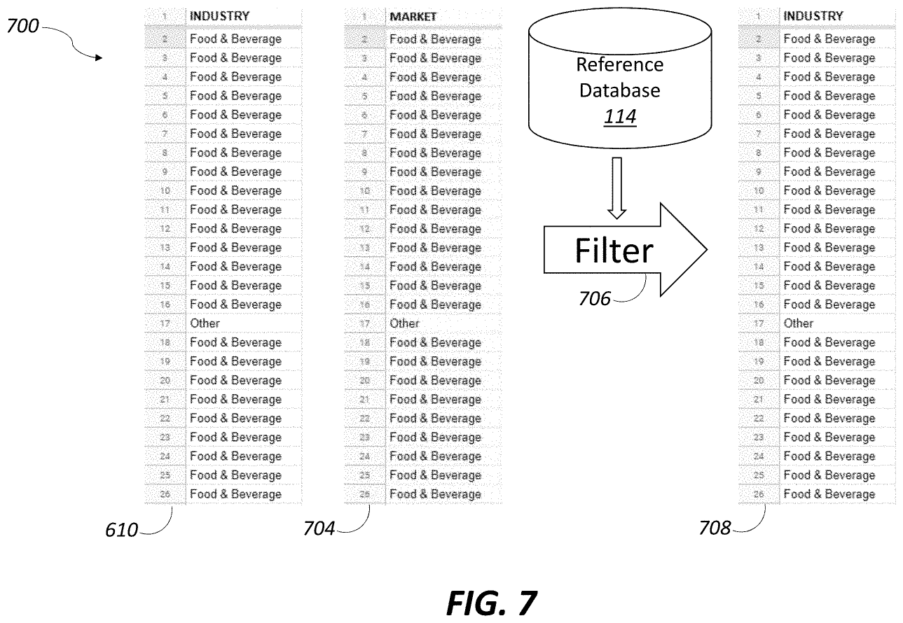

In these or other embodiments, the computing system may be configured to filter member input data into unique data fields. For example, the computing system may be configured to filter member input data and populate more than one individual data fields based on the member input data. Additionally, in this particular example, the computing system may then delete any duplicative data fields within the populated individual data fields to determine at least one unique data field. In these or other embodiments, the computing system may delete any duplicative data fields by referring to reference databases that check one or more data fields for any terms that may be synonymous to other terms in the data fields. Additionally or alternatively, the computing system may delete any duplicative data fields by comparing the data field values in two or more individual data fields for identity or substantial similarity of the data field values. Population of individual data fields and deletion of duplicative data fields will be described in more detail below in relation to FIGS. 6A, 6B, and 7.

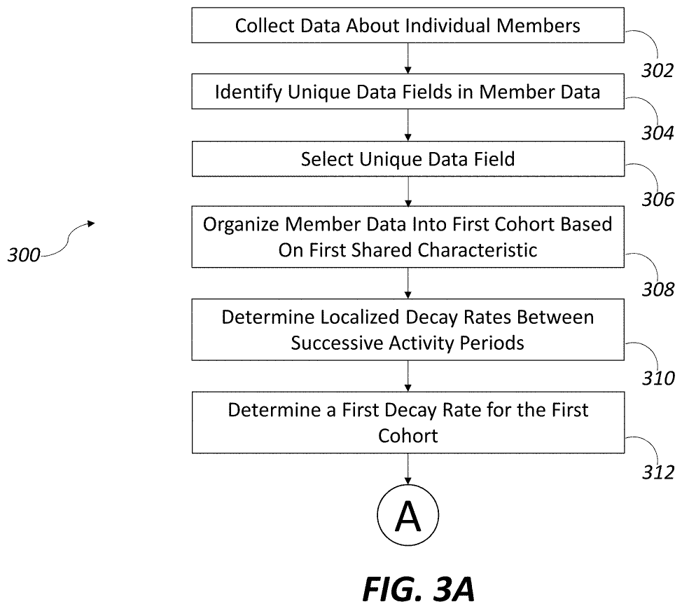

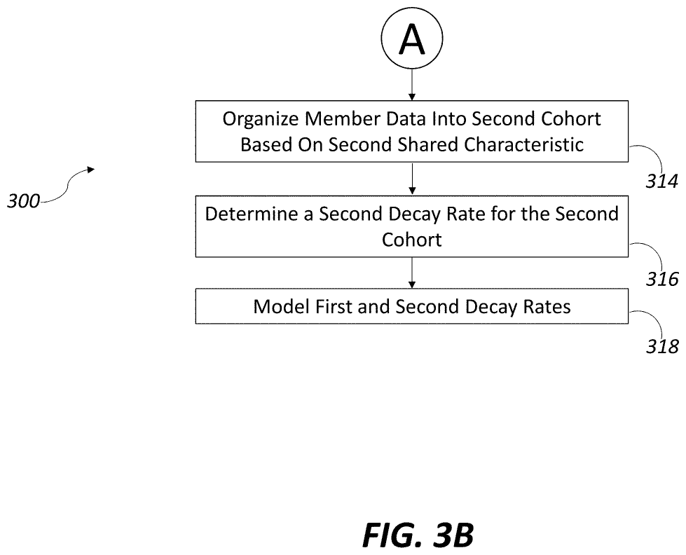

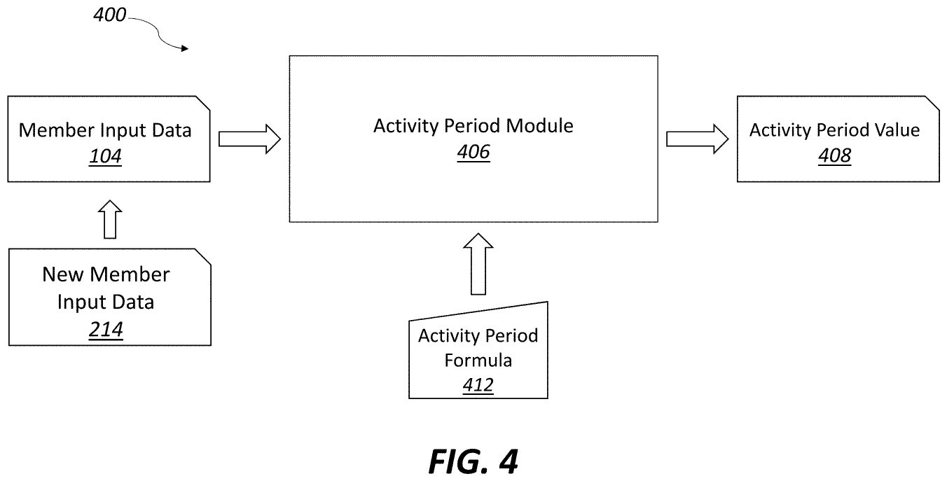

According to an embodiment of the present disclosure, the computing system may be configured to determine activity periods for each member of the member input data. For example, the computing system may be configured to filter member input data into individual data fields containing members' join dates and leave dates. In these or other embodiments, the computing system may use the members' join dates and leave dates to determine activity periods for the members. Determination of members' activity periods will be described in more detail below in relation to FIGS. 3A, 3B, and 4.

In these or other embodiments, the computing system may be configured to determine decay rates for cohorts sharing characteristics in the same unique data field. For example, the computing system may be configured to determine at least one localized decay rate between at least two activity periods for each member of a group of subscribers. In these or other embodiments, the computing system may use the at least one localized decay rate to determine one or more decay rates for the cohort that each corresponds to a shared characteristic with respect to a given unique data field. In these or other embodiments, the computing system may then determine at least one general decay rate for the member input data with respect to the given unique data field.

Some embodiments described herein include uses of the information associated with the decay rates that have been determined according to methods described herein, such as managing databases that contain information about subscribers, members or other entities that constitute the cohorts that have been analyzed. The information can also be used to provide reports for managers having responsibility for conducting marketing campaigns directed to existing or potential new subscribers or members or for making financial projections or analysis of past performance of marketing or retention activities. Other embodiments extend to computers, computer networks, or user interfaces that display or otherwise communicate the information associated with the decay rates and permit users to interact therewith.

Embodiments of the present disclosure are explained with reference to the accompanying drawings.

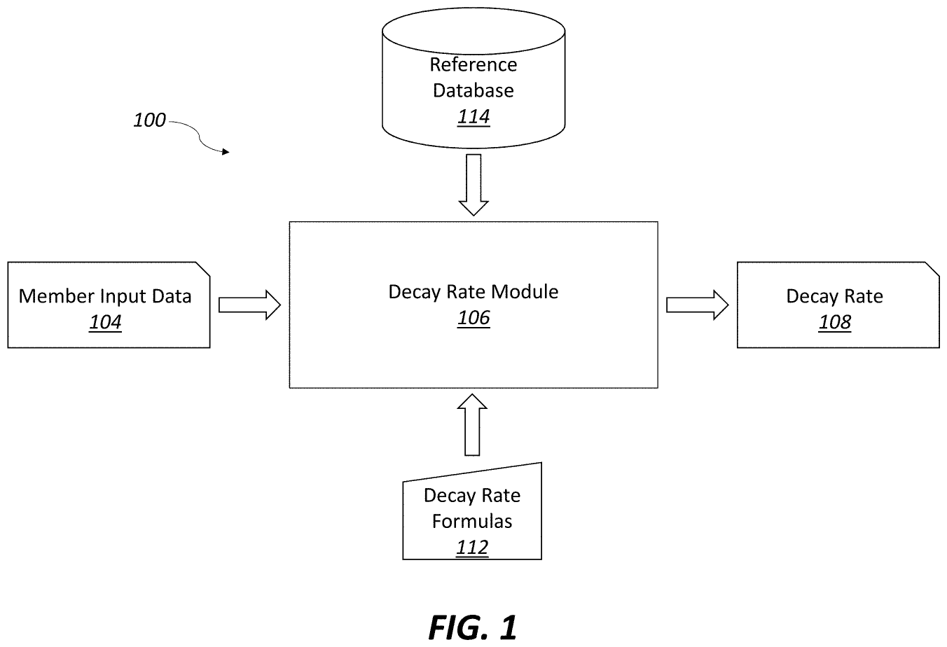

FIG. 1 is a diagram representing an example environment 100 related to determining decay rates 108 based on member input data 104, arranged in accordance with at least one embodiment described in the present disclosure. The environment 100 may include a decay rate module 106 configured to receive and analyze member input data 104 to determine one or more decay rates 108. In these or other embodiments, the decay rate module 106 in the environment 100 may be configured to receive and use at least one decay rate formula 112 or at least one reference database 114 in determining the one or more decay rates 108.

The member input data 104 may include information about multiple members in a group of subscribers. In some embodiments, the members may include a first cohort that is associated with a first characteristic, wherein the first characteristic is associated with a first unique data field as described in more detail below in relation to FIGS. 3A and 3B. In some embodiments, the member input data 104 may include the join dates and leave dates for the members in the group. In these and other embodiments, the decay rate module 106 may refer to the at least one decay rate formula 112 and each member's join dates and leave dates to calculate the amount of time the each member has been part of the group. Additionally or alternatively, the amount of time the one or more members were part of the group may be represented in temporal units including, but not limited to, seconds, minutes, hours, days, weeks, months, or years. In some embodiments, the member input data 104 may be stored in any suitable database. Additionally or alternatively, the member input data 104 may be manually input by a user. By way of example, the member input data 104 may include information from member subscription forms, academic or experimental research data sets, customer metadata, social media profiles, etc.

The decay rate module 106 may include code and routines configured to enable a computing device to perform one or more operations with respect to the member input data 104 to obtain the one or more decay rates 108. Additionally or alternatively, the decay rate module 106 may be implemented using hardware including a processor, a microprocessor (e.g., to perform or control performance of one or more operations), a field-programmable gate array (FPGA), or an application-specific integrated circuit (ASIC). In some other instances, the one or more decay rate modules 106 may be implemented using a combination of hardware and software. In the present disclosure, operations described as being performed by the decay rate module 106 may include operations that the decay rate module 106 may direct a corresponding system to perform.

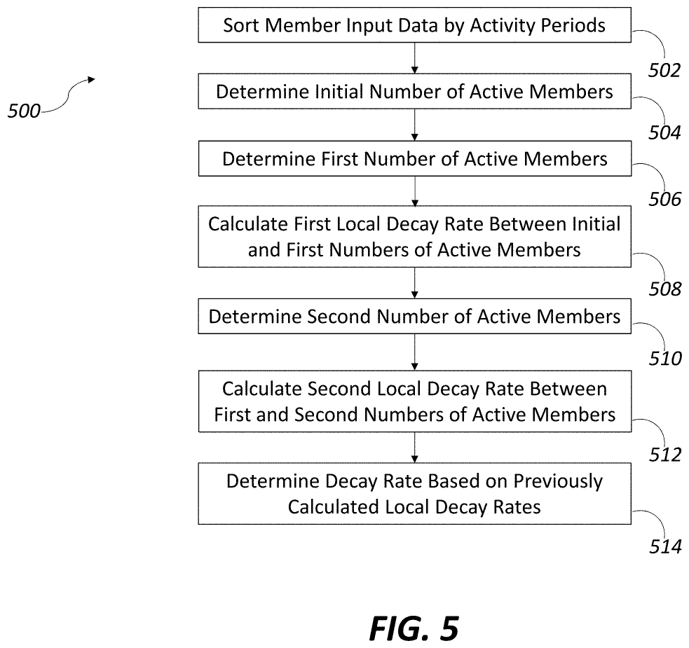

The decay rate module 106 may be configured to receive member input data 104. In some embodiments, the decay rate module 106 may be configured to receive code and routines from at least one decay rate formula 112. For example, the decay rate module 106 may receive code and/or routines from the at least one decay rate formula 112 for calculating general decay rates, decay rates, and/or localized decay rates as described below in relation to FIG. 5. Additionally or alternatively, the decay rate module 106 may be configured to receive code and routines from at least one reference database 114 to improve filtering of multiple data fields for determining one or more unique data fields as described below in relation to FIG. 7.

The decay rate module 106 may be configured to perform a series of operations with respect to the member input data 104. In some embodiments, the decay rate module 106 may be configured to output one or more decay rates 108 as a response to member input data 104. For example, the decay rate module 106 may receive member input data, identify unique data fields and cohorts from the member input data, and determine decay rates for the cohorts based on each member's activity period within the group of subscribers.

Additionally or alternatively, the decay rate module 106 may be configured to perform operations based on the code and routines from the at least one decay rate formula 112. For example, the at least one decay rate formula 112 may provide code and/or algorithms for calculating the general decay rate, decay rate, and/or localized decay rates for a given cohort. By way of example, the at least one decay rate formula 112 may instruct the decay rate module 106 on how to calculate localized decay rates based on members' activity periods or how to calculate at least one decay rate based on localized decay rates. For example, the at least one decay rate formula 112 may instruct the decay rate module 106 to take the product of one or more localized decay rates to determine at least one decay rate. Additionally or alternatively, the decay rate module 106 may be configured to perform operations based on the code and routines from the at least one reference database 114 as described in detail below in relation to FIG. 7.

In some embodiments, the at least one decay rate 108 may represent the rate at which members in a cohort leave the larger overall group of subscribers. The at least one decay rate 108 may include one or more decay rate values responsive to the operations performed by the decay rate module 106. In some embodiments, the at least one decay rate 108 may include one or more decay rate values provided by the decay rate module 106 and responsive to operations performed on some or all of the member input data 104 by the at least one decay rate formula 112. Additionally or alternatively, the at least one decay rate 108 may include one or more decay rate values provided by the decay rate module 106 and responsive to operations performed on some or all of the member input data 104 by the at least one reference database 114.

The one or more decay rate formulas 112 may include any suitable type of instructions or routines that, when executed, may be configured to implement on the one or more decay rate modules 106 one or more functions relating to the member input data 104. The functions relating to the member input data 104 may include transformations of member input data 104 or performance of calculations relating to member input data 104 in which the at least one decay rate 108 may be an output. Additionally or alternatively, one or more decay rate formulas 112 may include any suitable software that references one or more entries from the one or more reference databases 114 to perform operations relating to member input data 104.

The at least one reference database 114 may include at least one suitable database that the decay rate module 106 may refer to for implementing decay rate formulas 112. In some embodiments, the at least one decay rate formula 112 may refer to the at least one reference database 114 to perform operations relating to the member input data 104. In some embodiments, the decay rate module 106 may use entries from the at least one reference database 114 as input values in addition to the member input data 104 when implementing the at least one decay rate formula 112. By way of example, the at least one reference database 114 may include databases containing information about synonymous data field names, similar terms in data entries, tolerance ranges for quantitative data entries, etc.

Modifications, additions, or omissions may be made to FIG. 1 without departing from the scope of the present disclosure. For example, the environment 100 may include more or fewer elements than those illustrated and described in the present disclosure. For instance, in some embodiments, the environment 100 may include the decay rate module 106 and at least one the decay rate formula 112 but not the reference database 116 and in other embodiments the environment 100 may include the decay rate module 106 and the reference database 116 but not the at least one decay rate formula 112. For instance, the decay rate module 106 may include more than one decay rate modules. In addition, in some embodiments, one or more decay rate modules 106, one or more reference databases 114, and/or one or more decay rate formulas 112 may be combined such that they may be considered the same element or may have common sections that may be considered part of the decay rate module 106.

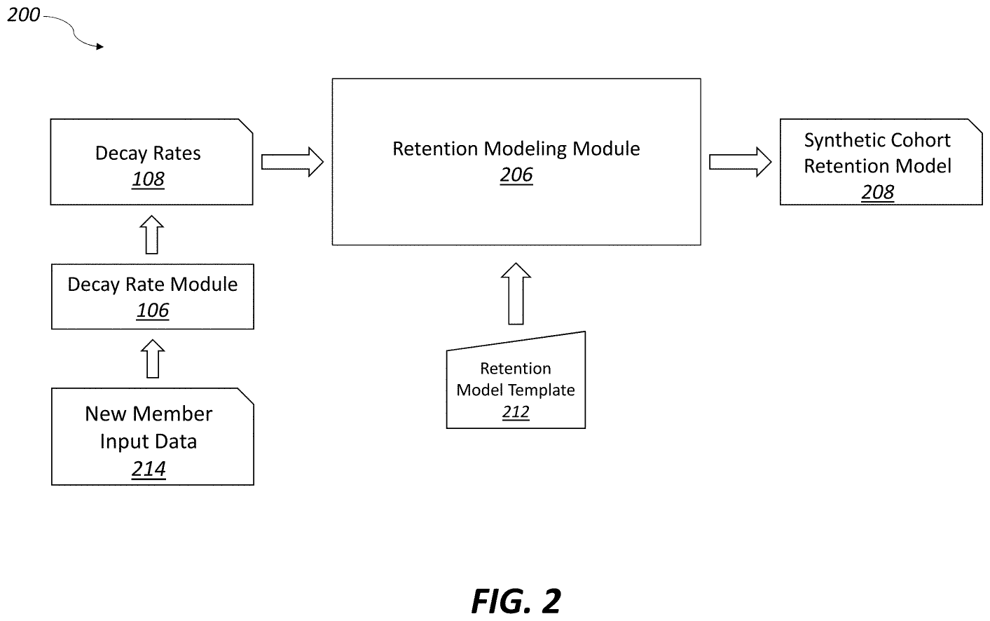

FIG. 2 is a diagram representing an example environment 200 related to modeling one or more decay rates 204 in at least one synthetic cohort retention model 208, arranged in accordance with at least one embodiment described in the present disclosure. The environment 200 may include a retention modeling module 206 that may receive and analyze the one or more decay rates 108 output by the decay rate module 106 to output at least one synthetic cohort retention model 208. In these or other embodiments, the environment 200 may include a retention modeling module 206 configured to receive and use a retention model template 212. Additionally or alternatively, the environment 200 may allow the decay rate module 106 to receive and analyze new member input data to update the one or more decay rates 108 and the synthetic cohort retention model 208.

The retention modeling module 206 may include code and routines configured to enable a computing device to perform one or more operations with respect to the one or more decay rates 108 to output the synthetic cohort retention model 108. Additionally or alternatively, the retention modeling module 206 may be implemented using hardware including a processor, a microprocessor (e.g., to perform or control performance of one or more operations), a field-programmable gate array (FPGA), or an application-specific integrated circuit (ASIC). In some other instances, the retention modeling module 206 may be implemented using a combination of hardware and software. In the present disclosure, operations described as being performed by the retention modeling module 206 may include operations that the retention modeling module 206 may direct a corresponding system to perform.

The retention modeling module 206 may be configured to receive one or more decay rates 108 as an input. In some embodiments, the retention modeling module 206 may be configured to receive code and routines from a retention model template 212. Additionally or alternatively, the retention modeling module 206 may be configured to receive at least one updated decay rate 108 responsive to new member input data 214 as an input. In these or other embodiments, the retention modeling module 206 may be configured to perform a series of operations with respect to the one or more decay rates 108. In some embodiments, the retention modeling module 206 may be configured to output a synthetic cohort retention model 208 as a response to the one or more decay rates 108. By way of example, the synthetic cohort retention model 208 may be a cohort decay graph, surface plot, infographic, etc. that represents the one or more decay rates 108.

Additionally or alternatively, the retention modeling module 208 may be configured to perform operations based on the code and routines from the at least one retention model template 212 as described below. Additionally or alternatively, the retention modeling module 206 may be configured to perform operations based on updates to the one or more decay rates 108 resulting from new member input data 214 as described below.

Synthetic cohort retention model 208 may include a model that may represent the one or more decay rates 108, responsive to the operations performed by the retention modeling module 206. In some embodiments, the synthetic cohort retention model 208 may include a model responsive to operations performed on some or all of the one or more decay rates 108 by the retention modeling module 206 and the retention model template 212. Additionally or alternatively, the synthetic cohort retention model 208 may include a model responsive to new member input data 214.

Retention model template 212 may include any suitable type of instructions or routines that, when executed, may be configured or implemented by the retention modeling module 206. In some embodiments, the types of instructions or routines provided by the retention model template 212 may include one or more software programs or code configured to enable the retention modeling module 206 to output the synthetic cohort retention model 208. Additionally or alternatively, the retention model template 212 may include one or more software programs or code configured to enable the retention modeling module 206 to graphically represent the synthetic cohort retention model 208. For example, the retention modeling module 206 may create a visual representation of the one or more decay rates 108, displayed as the synthetic cohort retention model 208, based on code or routines provided by the retention model template 212. The retention model template 212 may provide code or routines that instruct the retention modeling module 206 on how to transform the one or more received decay rates 108 into the synthetic cohort retention model 208. For example, the retention model template 212 may be an infographic template with variable fields for different decay rate values. Additionally or alternatively, for example, the retention model template 212 may include a function for plotting the one or more decay rates 108 and a graphical template for displaying the plotted graph. Additionally or alternatively, the retention model template 212 may include any suitable software that references the new member input data 214 to perform operations relating to the new member input data 214.

New member input data 214 may include any member input data introduced to environment 200 after the decay rate module 106 has received and analyzed member input data 104 and output at least one decay rate 108. In these or other embodiments, the new member input data 214 may include member input data having substantially similar or identical data fields to the data fields in member input data 104. For example, the new member input data 214 may include information about a new member that joined the group of subscribers. For example, the information about the new member may include the new member's join date, age, and occupation, and the information about existing members may also include the existing members' join dates, ages, and occupations.

In these or other embodiments, the new member input data 214 may include member input data having substantially or completely different data fields to the data fields in member input data 104. For example, the information about the new member may include the new member's join date, age, occupation, and whether the new member pays a discounted subscription fee when the information about existing members only includes the existing members' join dates, ages, and occupations. In some embodiments, reception of the new member input data 214 may be automatically incorporated into the decay rate module 106, and subsequently, the retention modeling module 206 automatically updates the synthetic cohort retention model 208. For example, the decay rate module 106 may analyze the new member's information, determine that the new member should be part of a cohort that includes members with a shared occupation, and update the one or more decay rates 108 to reflect the addition of one more member based on decay rate formula 112. Additionally or alternatively, should the new member leave the group, the decay rate module 106 may update the one or more decay rates 108 based on decay rate formula 112 to reflect that one more member has left the group of subscribers. Additionally or alternatively, the retention modeling module 206 and retention model template 212 may update the synthetic cohort retention model 208 to reflect the updated one or more decay rates 108.

Modifications, additions, or omissions may be made to FIG. 2 without departing from the scope of the present disclosure. For example, the environment 200 may include more or fewer elements than those illustrated and described in the present disclosure. For instance, in some embodiments, the environment 200 may include the retention modeling module 206 and the synthetic cohort retention model 208 but not the retention model template 212. For instance, in other embodiments, the retention modeling module 206 may include more than one retention modeling modules, the retention model template 212 may include more than one retention model template, and/or the retention modeling module 206 may output more than one synthetic cohort retention models 208. In addition, in some embodiments, one or more retention modeling modules 206 and one or more retention model templates 212 may be combined such that they may be considered the same element or may have common sections that may be considered part of the retention modeling module 206.

FIG. 3A is a flowchart of an example method 300 for determining one or more decay rates 108 based on member input data 104 and modeling the decay rates in a synthetic cohort retention model 208. The example method 300 may be performed by any suitable system, apparatus, or device. For example, the decay rate module 106 of FIG. 1, the retention modeling module 206 of FIG. 2, the activity period module 406 of FIG. 4, the decay rate formula 112 of FIG. 1, the reference database 114 of FIG. 1, the retention model template 212 of FIG. 2, or the activity period formula 412 of FIG. 4 may perform one or more of the operations associated with the example method 300. Although illustrated with discrete blocks, the steps and operations associated with one or more of the blocks of the example method 300 may be divided into additional blocks, combined into fewer blocks, or eliminated, depending on the particular implementation.

The example method 300 may begin at block 302, where data about individual members of a group of subscribers of a particular activity may be collected to compile a set of member input data for synthetic cohort retention analysis and modeling. In some embodiments at block 302, the member input data collected for each member of a group of subscribers of a particular activity may comprise a plurality of input data fields in which each input data field relates to a corresponding characteristic associated with one or more of the members. For example, the corresponding characteristics associated with one or more of the members may include “Entertainment,” “Fitness/Health,” “Food/Beverages,” “Real Estate,” and/or “Banking” when the unique data field is “Occupations.” Additionally, in this particular example, the corresponding characteristics associated with one or more members may also include “Yes” or “No” when the unique data field is “Did member join using a discount or deal?” Additionally, in this particular example, the corresponding characteristics associated with one or more members may also include “10 and under,” “11-17,” “18-20,” “21-29,” “30-39,” “40-49,” “50-59,” “60-69,” and “70 and older” when the unique data field is “Member Age.” In this or other embodiments, the member input data may be collected from one source or multiple sources. Additionally or alternatively, the source or sources of member input data may be one or more tables of data or one or more databases. For example, the source or sources of member input data may be member subscription forms, academic or experimental research, customer metadata, social media profiles, etc. In these and other embodiments, collection of member input data from the source or sources of member input data may be achieved through any applicable method.

At block 304, one or more unique data fields may be identified based on the collected member input data from block 302. In some embodiments, unique data fields may be identified based on the plurality of input data fields received and identified from the collected member input data to create a plurality of unique data fields. In some embodiments, software programs, code, or routines may identify the one or more unique data fields. In these and other embodiments, software programs, code, or routines may implement algorithms, formulas, computational processes, or the like to detect any duplicative data fields. Additionally or alternatively, software programs, code, or routines may delete any duplicative data fields detected in the collected member input data or select the one or more unique data fields from all of the collected data fields. Additionally or alternatively, software programs, code, or routines may determine if there are any duplicative data fields based on the collected member input data in each of the collected data fields. For example, in these or other embodiments, software programs, code, or routines may check collected member input data in each of the collected data fields to determine if collected member input data is identical or substantially similar to collected member input data in each of the other collected data fields. In some embodiments, the one or more unique data fields may be identified as described in detail below with respect to diagram 700 in FIG. 7.

At block 306, one or more unique data fields from the plurality of unique data fields may be selected. In some embodiments, selection of the one or more unique data fields may be based on programmed software, code, or routines. Additionally or alternatively, selection of the one or more unique data fields may be iterative and automatic. Additionally or alternatively, selection of the one or more unique data fields may be influenced by machine-learning software or processors. Additionally or alternatively, a user may manually select the one or more unique data field based on a first characteristic of interest to the end user. Additionally or alternatively, a user may select or provide a characteristic, and the system may identify a particular unique data field that corresponds to that characteristic by any applicable method. In some embodiments, it is contemplated that more than one unique data field may be selected, and it is further contemplated that more than one unique data field may be analyzed by decay rate module 106.

In some embodiments, the example method 300 may include organizing the collected member input data into cohorts based on shared characteristics relating to a unique data field at block 308. In some embodiments, organizing the collected member input data at block 308 may include identifying, as a first cohort, a first plurality of members that is associated with a respective first data value of the first unique data field that satisfies the first characteristic. For example, a first unique data field may be “Did the member join the group using a discount or deal.” The collected member input data may include information regarding whether each individual member paid full price for group membership. In this particular example, the source of the member input data may include a membership receipt that indicates the price the member paid to join the group. In this particular example, if the membership receipt indicates the member paid less than the full price for membership, the member input data may indicate “No.” In this particular example, the decay rate module 106 may then determine that all of the data field values responsive to the first unique data field are either “Yes” or “No.” In this particular example, the decay rate module 106 may identify, as a first cohort, a first plurality of members in which the collected member input data contain the data field value of “Yes.” Additionally or alternatively, organizing the collected member input data at block 314 as described below for identifying, as a second cohort, a second plurality of members that is associated with a respective second data value of the first unique data field that satisfies a second characteristic may be the same process as described here in relation to block 308. In this particular example, the decay rate module 106 may identify, as a second cohort, a second plurality of members in which the collected member input data contain the data field value of “No.”

In some embodiments, the example method 300 may include determining at least one localized decay rate for the first cohort between successive activity periods at block 310, wherein the localized decay rate represents the decay rate between two successive activity periods. For example, if the decay rate module 106 determines that there have been one hundred members in the cohort that have been remained in the group for at least 0 days, months, weeks, etc., then the number of members at the zeroth activity period is one hundred. If the decay rate module 106 determines that there have been ninety-five members in the cohort that have remained in the group for at least 1 day, month, week, etc., then the number of members at the first activity period is ninety-five. In this particular example, the decay rate module 106 may calculate a first localized decay rate between the zeroth and first activity periods based on the change in the number of members that have remained in the group. In this particular example, the first localized decay rate may be calculated by dividing the difference between the number of members in the zeroth and first activity periods and dividing that difference by the number of members in the zeroth activity period.

In some embodiments, the example method 300 may include determining a first decay rate for the first cohort with respect to participation in the particular activity by the first plurality of members at block 312, wherein the first decay rate represents decay in participation in the particular activity by members of the first cohort. In some embodiments, the first decay rate may be determined based on the at least one localized decay rate determined at block 310. For example, if the decay rate module 106 determines a first localized decay rate between a zeroth activity period and a first activity period is five percent and a second localized decay rate between the first activity period and a second activity period is ten percent, then decay rate module 106 may determine a first decay rate based on the first localized decay rate and the second localized decay rate. In this particular example, the decay rate module 106 may calculate the first decay rate by determining the percentage of remaining members after the second activity period based on the first localized decay rate and the second localized decay rate.

FIG. 3B is a continuation of the flowchart representing example method 300 for modeling the one or more decay rates using the synthetic cohort retention model 208 in FIG. 3A. The example method 300 of FIG. 3B, like the example method 300 of FIG. 3A, may also be performed by any suitable system, apparatus, or device. For example, the decay rate module 106 of FIG. 1, the retention modeling module 206 of FIG. 2, the activity period module 406 of FIG. 4, the decay rate formula 112 of FIG. 1, the reference database 114 of FIG. 1, the retention model template 212 of FIG. 2, or the activity period formula 412 of FIG. 4 may perform one or more of the operations associated with the example method 300. Although illustrated with discrete blocks, the steps and operations associated with one or more of the blocks of the example method 300 in FIG. 3B may also be divided into additional blocks, combined into fewer blocks, or eliminated, depending on the particular implementation.

In some embodiments, the example method 300 may include identifying, as a second cohort, a second plurality of members that is associated with a second shared characteristic of the first unique data field at block 314. In some embodiments, organizing the collected member input data at block 314 may include identifying, as a second cohort, a second plurality of members that is associated with a respective second data value of the first unique data field that satisfies the second characteristic. In some embodiments, identifying the second cohort at block 314 may be the same process as identifying the first cohort at block 308 as described above.

In some embodiments, the example method 300 may include determining a second decay rate for the second cohort at block 316. In some embodiments, determining the second decay rate for the second cohort may be based on the activity period for each member of the second plurality of members, wherein the second decay rate indicates decay in participation in the particular activity in relation to the second characteristic. In some embodiments, the second decay rate of the second cohort for the first unique data field may be determined as described in detail below with respect to example method 500 in FIG. 5.

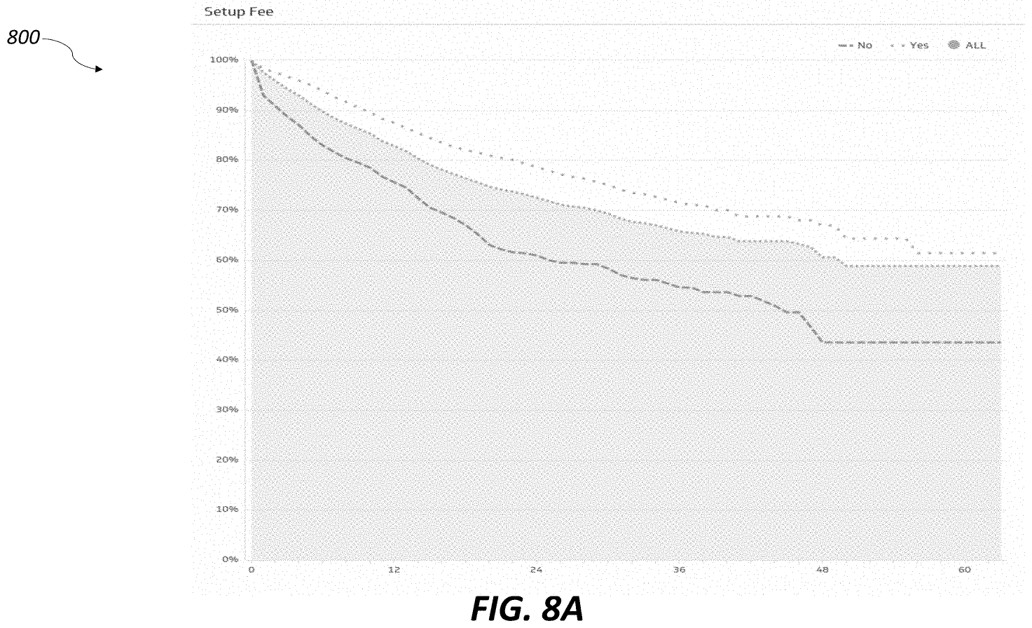

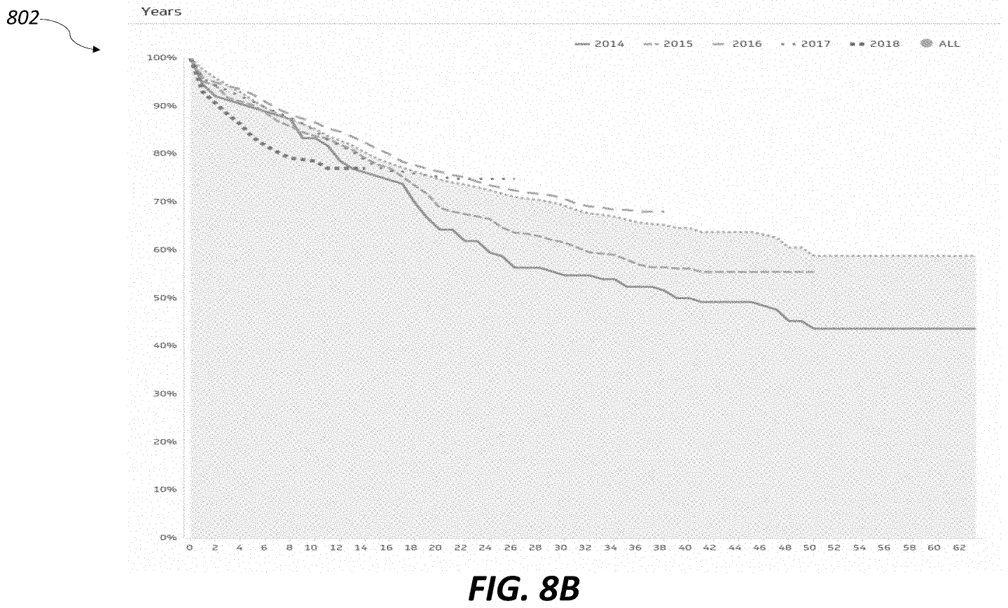

In some embodiments, the example method 300 may include modeling the first decay rate and the second decay rate in a cohort retention model at block 318. In some embodiments, the first decay rate and the second decay rate may be modeled in the same cohort retention model as described in detail below with respect to graphical diagrams 800 and 802 in FIGS. 8A and 8B. In some embodiments, the first decay rate and the second decay rate may be modeled in separate cohort retention models. Additionally or alternatively, the first decay rate and the second decay rate may be depicted in at least one of a variety of models. By way of example, the variety of models may include one or more of the following: cohort retention models, cohort retention tables, cohort decay graphs, surface plots, infographics, or mathematical regression functions

Modifications, additions, or omissions may be made to FIGS. 3A and 3B without departing from the scope of the present disclosure. For example, the example method 300 may include more or fewer steps than those illustrated and described in the present disclosure. For instance, in some embodiments, the example method 300 may include steps for organizing the collected member data into third, fourth, fifth, etc. cohorts based on third, fourth, fifth, etc. shared characteristics. Additionally or alternatively, the example method 300 may include steps for determining third, fourth, fifth, etc. decay rates for the third, fourth, fifth, etc. cohorts. In addition, in some embodiments, the synthetic cohort retention model 208 may model and display the third, fourth, fifth, etc. decay rates alongside or separately from models of the first decay rate and/or the second decay rate.

FIG. 4 is a diagram representing an example environment 400 related to determining one or more activity period values 408 for member input data 104. The environment 400 may include an activity period module 406 that may receive and analyze member input data 104 to output one or more activity period values 408. In some embodiments, the environment 400 may include an activity period module 406 configured to receive and use one or more activity period formulas 412. In these or other embodiments, the activity period module 406 may receive and analyze the member input data 104 and output one or more activity period values 408 prior to reception and analysis of the member input data 104 by the one or more decay rate modules 106 as described in relation to FIG. 1 above. Additionally or alternatively, the environment 400 may allow the activity period module 406 to receive and analyze new member input data 214 to update the incoming member input data 104 and the one or more activity period values 408.

Activity period module 406 may include code and routines configured to enable a computing device to perform one or more operations with respect to the member input data 104 to output the one or more activity period values 408. Additionally or alternatively, the one or more activity period modules 406 may be implemented using hardware including a processor or a microprocessor (e.g. to perform or control performance of one or more operations), a field-programmable gate array (FPGA), or an application-specific integrated circuit (ASIC). In some other instances, the activity period module 406 may be implemented using a combination of hardware and software. In the present disclosure, operations described as being performed by the activity period module 406 may include operations that the activity period module 406 may direct a corresponding system to perform.

Activity period value 408 may include one or more values responsive to operations performed by the activity period module 406 that may represent the member input data 104. In some embodiments, the one or more activity period values 408 may include one or more values provided by the activity period module 406 and responsive to operations performed by on some or all of the member input data 104 by the one or more activity period formulas 412. For example, the activity period module 406 may receive code or routines that allow the activity period module to identify the members' join dates and leave dates from the member input data 104. For example, in some embodiments, the code or routines received by the activity period module 406 may instruct the activity period module to identify data in the member input data relating to “Join Date,” “Leave Date,” or similar field names identified, for example, in a reference database 114. Additionally or alternatively, the one or more activity period values 408 may include one or more values provided by the activity period module 406 and responsive to inputting new member input data 214.

Activity period formula 412 may include any suitable types of instructions or routines that, when executed, may be configured or implemented by the activity period module 406. In some embodiments, the types of instructions or routines provided by the one or more activity period formulas 412 may include one or more software programs or code configured to enable the activity period module 406 to output the one or more activity period values 408. For example, activity period formula 412 may instruct activity period module 406 to calculate the number of days, weeks, months, years, etc., that have elapsed between each member's join date and leave date to determine each member's activity period value 408, in which the number of days, weeks, months, or years may be used as the corresponding activity period values. Additionally or alternatively, the one or more activity period formulas 412 may include any suitable instructions or routines that references the new member input data 214 to further perform the operations described above relating to calculation of activity period values for new member input data 214.

Modifications, additions, or omissions may be made to FIG. 4 without departing from the scope of the present disclosure. For example, the environment 400 may include more or fewer elements than those illustrated and described in the present disclosure. For instance, in some embodiments, the environment 400 may include the activity period module 406 but no activity period formulas 412. For instance, in other embodiments, the activity period module 406 may include more than one activity period modules, and the activity period formula 412 may include more than one activity period formulas. In addition, in some embodiments, one or more activity period modules 406 and one or more activity period formulas 412 may be combined such that they may be considered the same element or may have common sections that may be considered part of the activity period module 406.

FIG. 5 is a flowchart of an example method 500 for determining one or more decay rates 108 for a unique data field based on members' activity period values 408. The example method 500 may be performed by any suitable system, apparatus, or device. For example, the decay rate module 106 of FIG. 1, the activity period module 406 of FIG. 4, the decay rate formula 112 of FIG. 1, the reference database 114 of FIG. 1, or the activity period formula 412 of FIG. 4 may perform one or more of the operations associated with the example method 500. Although illustrated with discrete blocks, the steps and operations associated with one or more of the blocks of the example method 500 may be divided into additional blocks, combined into fewer blocks, or eliminated, depending on the particular implementation.

The example method 500 may begin at block 502, where member input data 104 may be sorted by the individual members' activity period values 408. In some embodiments, sorting the member input data 104 by each of the one or more individual member's activity period values 408 at block 502 may include separating active members and inactive members in the cohort. In some embodiments, sorting the member input data 104 may include calculating the inactive members' activity period values 408. In some embodiments, calculating and sorting the member input data 104 may include using the current date as the end date for calculating the active members' activity period values.

In some embodiments, the example method 500 may include determining an initial number of active members in a cohort at block 504. In these and other embodiments, the member input data may be organized by activity period values. For example, the members may be sorted and ordered based on ascending activity period values, which begin at 0 and ends in the highest activity period value amongst the members in the cohort. For example, the number of members within the member input data remaining in the cohort may then be tallied at each of the activity period increments such that the number of tallied members in the cohort decreases as the activity period values increase. In these and other embodiments, the activity period values may be assigned temporal units of seconds, minutes, hours, days, weeks, months, years, etc. In these and other embodiments, the initial number of active members may be the total number of members that have been part of the cohort for any period of time. By way of example, if activity period values are assigned as months, the initial number of active members may be equal to the number of members that have been part of the cohort for at least zero months. Furthermore in this example, the number of active members tallied at an activity period value of 5 may be the number of active members that have remained part of the group of subscribers for at least 5 months, inclusive of members who are inactive at the current time.

In some embodiments, the example method 500 may include determining a first number of active members in a cohort at block 506. In these and other embodiments, the first number of active members may be the total number of members that have been part of the cohort for at least one activity period increment. In these and other embodiments, the first number of active members may be determined by decrementing the number of members that became inactive between the zeroth activity period and the first activity period from the initial number of active members. By way of example, if the activity period is assigned as months, the first number of active members may be equal to the number of members that have been part of the cohort for at least one month.

At block 508, the example method 500 may include calculating a first decay rate between the initial number of active members and the first number of active members. In some embodiments, calculating the first decay rate may include comparing the number of members that became inactive between the zeroth activity period increment and the first activity period increment to the initial number of active members. By way of example, the first decay rate may be equal to the quotient of the initial number of active members and the number of members that became inactive between the zeroth activity period and the first activity period.

In some embodiments, the example method 500 may include determining a second number of active members in a cohort at block 510. In these and other embodiments, the second number of active members may be the total number of members that have been part of the cohort for at least two activity periods. In these and other embodiments, the second number of active members may be determined by decrementing the number of members that became inactive between the first activity period and the second activity period from the first number of active members. By way of example, if the activity period value is assigned as months, the second number of active members may represent the number of members that have been part of the cohort for at least two months. In some embodiments, the example method 500 may also include determining a third number of active members in a cohort at block 510. In these and other embodiments, the third number of active members may be the total number of members that have been part of the cohort for at least three activity periods. In these and other embodiments, the third number of active members may be determined by decrementing the number of members that became inactive between the second activity period and the third activity period from the second number of active members.

At block 512, the example method 500 may include calculating a second decay rate between the first number of active members and the second number of active members. In some embodiments, calculating the second decay rate may include comparing the number of members that became inactive between the first activity period and the second activity period to the first number of active members. In these and other embodiments, the example method 500 may also include calculating a third decay rate between the second number of active members and the third number of active members. In these and other embodiments, calculating the third decay rate may include comparing the number of members that became inactive between the second activity period and the third activity period to the second number of active members. By way of example, the second decay rate may be equal to the quotient of the first number of active members and the number of members that became inactive between the first activity period increment and the second activity period increment.

In some embodiments, the example method 500 may include determining a general decay rate based on the first decay rate and the second decay rate of the cohort with respect to the selected unique data field at block 514, the first decay rate and the second decay rate being representative of localized decay rates. In these and other embodiments, the general decay rate may initially be the product of two or more decay rates. In these and other embodiments, the at least one general decay rate may represent the overall rate of membership attrition for a given unique data field. In these and other embodiments, the example method 500 may include updating the general decay rate based on one or more subsequent localized decay rates and/or one or more decay rates. By way of example, the general decay rate may initially be calculated as the product of a first decay rate and a second decay rate, and a first decay rate may initially be calculated as the product of a first localized decay rate and a second localized decay rate. By way of example, the general decay rate may continue to change based on calculation of a third localized decay rate and subsequent localized decay rates. For example, the total number of members that have ever been part of a group may be one hundred members, and the current number of members may be fifty members. In this particular example, the decay rate module may calculate the general decay rate by dividing the difference between the total number of members that have ever been part of the group and current number of members by the total number of members that have ever been part of the group such that the general decay rate for this group is fifty percent. In these and other embodiments, the example method 500 may include updating the general decay rate based on changes to one or more localized decay rates or decay rates caused by reception of new member input data. For example, if the number of current members in the above example decreases to thirty, then the decay rate module may calculate the general decay rate to be seventy percent.

FIG. 6A illustrates an example set of member input data 600 that may be received and analyzed by the decay rate module 106 or the activity period module 406. As discussed above, the member input data 104 may include information from member subscription forms, academic or experimental research data sets, customer metadata, social media profiles, or any other types of information that may indicate characteristics associated with the members. By way of example, the example set of member input data 600 in FIG. 6A is a table of member input data. Additionally or alternatively, the member input data 104 may be a database of information, and an individual member's information may be one or more entries in the database of information. By way of example and illustration, the example set of member input data 600 in FIG. 6A includes an identifying column 601, year(START) column 603, months column 605, inactive column 607, change column 609, and industry column 611. In this specific example set of member input data 600, the identifying column 601 contains one row for each individual member. In this specific example set of member input data 600, the year(START) column 603 contains corresponding data values with respect to information relating to the year in which each individual member first joined the group, and the data values “2017,” “2018,” and “2019” may represent characteristics that may be associated with a given individual member of the group. In this specific example set of member input data 600, the months column 605 contains corresponding data values with respect to information relating to the number of months each individual member has been in the group, and the data values in the column may represent the activity periods for given individual members of the group. In this specific example set of member input data 600, the inactive column 607 contains corresponding data values with respect to information relating to each individual member's activity status within the group, and the data values “0” and “1” may represent characteristics that may be associated with a given individual member of the group. In this specific example set of member input data 600, the change column 609 contains corresponding data values with respect to information relating to any changes in the individual member's status within the group, and the data values “No Change,” “Upsell,” and “Downsell” may represent characteristics that may be associated with a given individual member of the group. In this specific example set of member input data 600, the industry column 611 contains corresponding data values with respect to information relating to the industry each individual member is a part of, and the data values “Food & Beverage” and “Other” may represent characteristics that may be associated with a given individual member of the group.

FIG. 6B illustrates example unique data fields 602, 604, 606, 608, and 610 based on the set of member input data 600 and columns of information about each individual member 601, 603, 605, 607, 609, and 611 of FIG. 6A in which the example unique data fields may be identified according to example method 300 at block 304. By way of example, the columns of information 601, 603, 605, 607, 609, and 611 in FIG. 6B may be separated into unique data fields 602, 604, 606, 608, and 610 according to block 304 of the example method 300 and as discussed in more detail below with respect to process 700 in FIG. 7.

By way of example, the unique data fields 602, 604, 606, 608, and 610 in FIG. 6B are separate tables containing some member input data. Additionally or alternatively, the unique data fields 602, 604, 606, 608, and 610 may comprise part of a database of information, and an individual unique data field may one data field in the database of information. Specifically in FIG. 6B, the unique data field 602 contains data values relating each individual member to the number of months the member has been in the group. In some embodiments, the unique data field 602 may be part of the member input data 104 received and analyzed by the one or more activity period modules 406 of environment 400 in FIG. 4. Specifically in FIG. 6B, the unique data field 604 contains data values relating each individual member to the year in which that member first joined the group, and the year in which a member first joined the group may be one characteristic of members in the group. Specifically in FIG. 6B, the unique data field 606 contains data values relating each individual member to each individual member's activity status within the group, and the activity status of a member may be one characteristic of members in the group. Specifically in FIG. 6B, the unique data field 608 contains information relating each individual member to any changes in the individual member's status within the group, and any change in a member's status may be one characteristic of members in the group. Specifically in FIG. 6B, the unique data field 610 contains data values relating each individual member to the industry each individual member is a part of, and a member's industry may be one characteristic of members in the group. In some embodiments, the unique data fields 604, 606, 608, or 610 may be part of the member input data 104 received and analyzed by the one or more decay rate modules of environment 100 in FIG. 1.

FIG. 7 is an example environment 700 illustrating deletion of a duplicate data field 704 to determine a unique data field 708. The example environment 700 may include multiple data fields 610 and 704 from an initial set of collected member input data. In this particular example, data field 610 is the industry data field 610 of FIG. 6B, and data field 704 is a market data field. In these and other embodiments, the example environment 700 may further include a step for processing the multiple data fields 610 and 704 via filter 706. For example, the filter 706 may receive instructions, routines, software programs, or code from at least one reference database 114. For example, in these and other embodiments, one or more of the multiple data fields 610 and 704 may be deleted by the filter 706, and a unique data field 708 may be outputted after processing the multiple data fields 610 and 704.

By way of example, the data field 704 in FIG. 7 may be a market data field collected from the member input data 104. In this particular example, the market data field 704 may represent identical data as another data field. In this particular example, the market data field 704 represents identical data as the industry data field 610. In some embodiments, the data field 704 may represent substantially similar data as another data field 610. In this particular example, changes to one row of data in the market data field 704 would prevent the market data field 704 from being identical to the industry data field 610, but the market data field 704 may still be substantially similar to the industry data field 610. Additionally or alternatively in this particular example, removal of data from one row in the market data field 704 would also prevent the market data field 704 from being identical to the industry data field 610, but the market data field 704 may still be substantially similar to the industry data field 610.

In some embodiments, the filter 706 may include instructions, routines, software programs, or code capable of recognizing duplicate data fields in a set of data fields. In this particular example environment 700, the multiple data fields 610 and 704 comprise a set of data fields to which the filter 706 may apply instructions, routines, software programs, or code to determine if duplicate data fields exist in the multiple data fields 610 and 704. In these and other embodiments, the filter 706 may further receive instructions, routines, software programs, or code from one or more reference databases 114 to improve the ability of filter 706 to recognize duplicate data fields. By way of example, the filter may check the names of the multiple data fields 610 and 704 and refer to a reference database 114 containing information about synonymous data field names to determine if a duplicate data field exists. In this particular example, if the name of data field 610, “INDUSTRY,” and the name of data field 704, “MARKET,” are synonyms in the synonymous names database, the filter 706 may recognize one or more of the multiple data fields 610 and 704 as one or more duplicate data fields. In this particular example, the filter 706 may then delete one or more of the duplicate data fields until a single unique data field 708 remains.

In these and other embodiments, the filter 706 may include instructions, routines, software programs, or code enabling the filter 706 to recognize identical or substantially similar data fields. Additionally or alternatively, the filter 706 may delete one or more data fields recognized as identical or substantially similar to one or more other data fields. In this particular example, the filter may check at least one row of the multiple data fields 610 and 704 and refer to the instructions, routines, software programs, or code enabling the filter 706 to recognize identical or substantially similar data fields to determine if a duplicate data field exists. In this particular example, if the entries of data field 610 and the entries of data field 704 are considered identical or substantially similar, the filter 706 may recognize one or more of the multiple data fields 610 and 704 as one or more duplicate data fields. In this particular example, the entries of data field 610 and the entries of data field 704 may be considered substantially similar if the filter 706 recognizes that a threshold percentage of the data entries determined by instructions, routines, software programs, and/or code contain identical or substantially identical types of information or information. In this particular example, the filter 706 may then delete one or more of the duplicate data fields 704 until a single unique data field 708 remains.

In some embodiments, the unique data field 708 may be comprised of data identical to data in one of the multiple data fields 610 and 704. Additionally or alternatively, the unique data field 708 may be comprised of data from one or more of the multiple data fields 610 and 704. In these and other embodiments, the unique data field 708 may be comprised of data substantially similar to one or more of the multiple data fields 610 and 704. In these and other embodiments, the filter 706 may include instructions, routines, software programs, or code enabling the filter 706 to combine data from more than one of the multiple data fields 610 and 704 or delete data from one or more of the multiple data fields 610 and 704 in determining the unique data field 708. In some embodiments, a user may select which of the multiple data fields 610 and 704 are deleted in determining the unique data field 708.

By way of example, data field 610 in FIG. 7 may be comprised of data indicating which industry each member operates in, but data field 610 may be missing data from one or more members. By way of example and illustration, data field 704 may be comprised of data substantially similar to the data in data field 610, but data field 704 may be missing data from one or more members. By way of example, unique data field 708 may be comprised of data from only data field 610 or only data field 704. By way of example, unique data field 708 may be comprised of data from data field 610 and data from data field 704 where data field 610 is missing data from one or more members. By way of example, unique data field 708 may be comprised of data from data field 704 and data from data field 610 where data field 704 is missing data from one or more members.

FIG. 8A illustrates an example cohort retention model 800 based on a binary unique data field. In this and other embodiments, a binary unique data field may be a unique data field in which the members may only be organized into two cohorts because members responsive to the unique data field can only exhibit one of two characteristics. In this particular example, the cohort retention model 800 may represent synthetic cohort retention modeling of at least one unique data field containing information relating to whether each individual member of the cohort paid a setup cost when joining the group in which all members of the cohort satisfy the characteristic of “Yes” or the characteristic of “No.” FIG. 8B illustrates an example cohort retention model 802 based on a non-binary unique data field. In this and other embodiments, a non-binary unique data field may be a unique data field in which the members may be organized into more than two cohorts because members responsive to the unique data field can exhibit one of more than two characteristics. In this particular example, the cohort retention model 802 may represent synthetic cohort retention modeling of at least one unique data field containing information relating to the year in which each individual member first joined the group. In this particular example, the cohort retention model 802 may be a model based on the unique data field 604 of FIG. 6B.

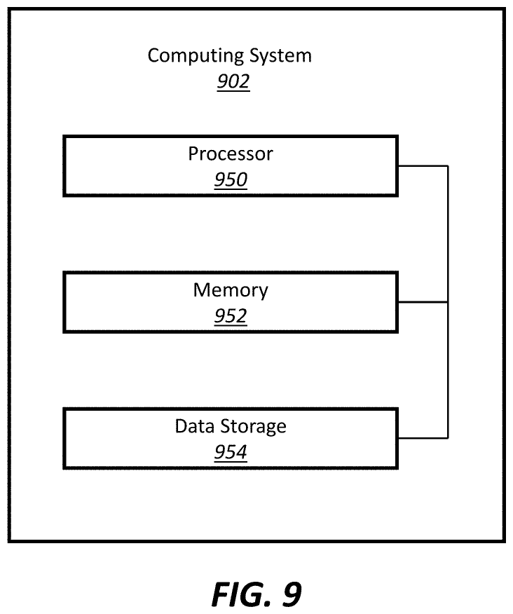

FIG. 9 illustrates a block diagram of an example computing system 902, according to at least one embodiment of the present disclosure. The computing system 902 may be configured to implement or direct one or more operations associated with cohort analysis such as described in the present disclosure. The computing system 902 may include a processor 950, a memory 952, and a data storage 954. The processor 950, the memory 952, and the data storage 954 may be communicatively coupled.

In general, the processor 950 may include any suitable special-purpose or general-purpose computer, computing entity, or processing device including various computer hardware or software modules and may be configured to execute instructions stored on any applicable computer-readable storage media. For example, the processor 950 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 9, the processor 950 may include any number of processors configured to, individually or collectively, perform or direct performance of any number of operations described in the present disclosure. Additionally, one or more of the processors may be present on one or more different electronic devices, such as different servers.

In some embodiments, the processor 950 may be configured to interpret and/or execute program instructions and/or process data stored in the memory 952, the data storage 954, or the memory 952 and the data storage 954. In some embodiments, the processor 950 may fetch program instructions from the data storage 954 and load the program instructions in the memory 952. After the program instructions are loaded into memory 952, the processor 950 may execute the program instructions.

For example, in some embodiments, the methods and/or modules described herein may be included in the data storage 954 as program instructions. The processor 950 may fetch the program instructions from the data storage 954 and may load the program instructions in the memory 952. After the program instructions are loaded into memory 952, the processor 950 may execute the program instructions such that the computing system may implement the operations associated with the methods and/or modules as directed by the instructions.

The memory 952 and the data storage 954 may include computer-readable storage media for carrying or having computer-executable instructions or data structures stored thereon. Such computer-readable storage media may include any available media that may be accessed by a general-purpose or special-purpose computer, such as the processor 950. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 950 to perform a certain operation or group of operations.

Modifications, additions, or omissions may be made to the computing system 902 without departing from the scope of the present disclosure. For example, in some embodiments, the computing system 902 may include any number of other components that may not be explicitly illustrated or described.

As indicated above, the embodiments described in the present disclosure may include the use of a special purpose or general purpose computer including various computer hardware or software modules, as discussed in greater detail below. Further, as indicated above, embodiments described in the present disclosure may be implemented using computer-readable media for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method for cohort retention analysis, the method comprising:
collecting member input data for each member of a group of subscribers of a particular activity, wherein the member input data has a plurality of input data fields in which each input data field relates to a corresponding characteristic associated with one or more of the members;
identifying a unique data field for each input data field of the plurality of input data fields to create a plurality of unique data fields;
determining an activity period for the each member;
selecting a first unique data field from the plurality of unique data fields, wherein selection of the first unique data field is in response to a user's first query being with respect to a first characteristic related to the first unique data field;
identifying, as a first cohort, a first plurality of members that is associated with the first characteristic in response to the first query being with respect to the first unique data field, the identifying of the first plurality of members being based on each member of the first plurality of members being associated with a respective first data value of the first unique data field that satisfies the first characteristic;
determining a first decay rate for the first cohort with respect to participation in the particular activity by the first plurality of members, the first decay rate being determined based on the activity period for each member of the first cohort, the first decay rate indicating decay in participation in the particular activity in relation to the first unique data field;
identifying, as a second cohort, a second plurality of members that is associated with a second characteristic in response to the first query being with respect to the first unique data field, the identifying of the second plurality of members being based on each member of the second plurality of members being associated with a respective second data value of the first unique data field that satisfies the second characteristic;
determining a second decay rate for the second cohort with respect to participation in the particular activity by the second cohort, the second decay rate being determined based on the activity period for each member of the second plurality of members, the second decay rate indicating decay in participation in the particular activity in relation to the first unique data field;
modeling the first decay rate and the second decay rate in a cohort retention model;
selecting a second unique data field from the plurality of unique data fields, wherein selection of the second unique data field is in response to a user's second query being with respect to a first characteristic related to the second unique data field;
identifying, as a third cohort, a third plurality of members that is associated with a third characteristic in response to the second query being with respect to the second unique data field, the identifying of the third plurality of members being based on each member of the third plurality of members being associated with a respective first data value of the second unique data field that satisfies the third characteristic;
determining a third decay rate for the third cohort with respect to participation in the particular activity by the third plurality of members, the third decay rate being determined based on the activity period for each member of the third plurality of members, the third decay rate indicating decay in participation in the particular activity in relation to the second unique data field;
identifying, as a fourth cohort, a fourth plurality of members that is associated with a fourth characteristic in response to the second query being with respect to the second unique data field, the identifying of the fourth plurality of members being based on each member of the fourth plurality of members being associated with a respective second data value of the second unique data field that satisfies the fourth characteristic;
determining a fourth decay rate for the fourth cohort with respect to participation in the particular activity by the fourth plurality of members, the fourth decay rate being determined based on the activity period for each member of the fourth plurality of members, the fourth decay rate indicating decay in participation in the particular activity in relation to the second unique data field;
modeling the third decay rate and the fourth decay rate in a cohort retention model; and
responsive to changes in the member input data, updating the cohort retention model automatically.

2. The method of claim 1, wherein the plurality of input data fields comprises one or more of:
member start date, member end date, use of promotions, member's industry, member demographics, member age, member income, member gender, member race, and type of membership.

3. The method of claim 1, wherein determining unique data fields based on the collected member input data comprises:
comparing data of a first data field and data of a second data field of the plurality of input data fields;
determining if the data of the first data field and the data of the second data field are identical; and
responsive to determining the data of the first data field and the data of the second data field are identical, deleting the second data field.

4. The method of claim 3, further comprising:
comparing a name of the first data field and a name of the second data field; and
responsive to determining the name of the first data field and the name of the second data field are synonymous, deleting the second data field.

5. The method of claim 1, wherein determining the activity period for the each member comprises:
determining a member start date and a member end date, wherein the member end date for active members is a current date; and
calculating the activity period for the each member based on the member start date and the member end date.

6. The method of claim 1, wherein determining the first decay rate for the cohort comprises:
determining an initial number of active members in an initial activity period;
decrementing a first number of members that become inactive from the initial number of active members in the initial activity period to determine a first number of active members;
calculating a first localized decay rate between the initial activity period and the first activity period;
decrementing a second number of members that become inactive from the first number of active members in the first activity period to determine a second number of active members;
calculating a second localized decay rate between the first activity period and the second activity period; and
multiplying the first localized decay rate and the second localized decay rate to determine a first decay rate.

7. The method of claim 1, further comprising:
determining a general decay rate for the cohort, wherein the general decay rate models a decay rate for all of the member input data; and
modeling the general decay rate alongside the first decay rate, the second decay rate, the third decay rate, and the fourth decay rate.

8. One or more non-transitory computer-readable storage media configured to store instructions that, in response to being executed by one or more processors, cause a system to perform operations, the operations comprising:
collecting member input data for each member of a group of subscribers of a particular activity, wherein the member input data has a plurality of input data fields in which each input data field relates to a corresponding characteristic associated with one or more of the members;
identifying a unique data field for each input data field of the plurality of input data fields to create a plurality of unique data fields;
determining an activity period for the each member;
selecting a first unique data field from the plurality of unique data fields, wherein selection of the first unique data field is in response to a user's first query being with respect to a first characteristic related to the first unique data field;
identifying, as a first cohort, a first plurality of members that is associated with the first characteristic in response to the first query being with respect to the first unique data field, the identifying of the first plurality of members being based on each member of the first plurality of members being associated with a respective first data value of the first unique data field that satisfies the first characteristic;
determining a first decay rate for the first cohort with respect to participation in the particular activity by the first plurality of members, the first decay rate being determined based on the activity period for each member of the first cohort, the first decay rate indicating decay in participation in the particular activity in relation to the first unique data field;
identifying, as a second cohort, a second plurality of members that is associated with a second characteristic in response to the first query being with respect to the first unique data field, the identifying of the second plurality of members being based on each member of the second plurality of members being associated with a respective second data value of the first unique data field that satisfies the second characteristic;
determining a second decay rate for the second cohort with respect to participation in the particular activity by the second cohort, the second decay rate being determined based on the activity period for each member of the second plurality of members, the second decay rate indicating decay in participation in the particular activity in relation to the first unique data field;
modeling the first decay rate and the second decay rate in a cohort retention model;
selecting a second unique data field from the plurality of unique data fields, wherein selection of the second unique data field is in response to a user's second query being with respect to a first characteristic related to the second unique data field;
identifying, as a third cohort, a third plurality of members that is associated with a third characteristic in response to the second query being with respect to the second unique data field, the identifying of the third plurality of members being based on each member of the third plurality of members being associated with a respective first data value of the second unique data field that satisfies the third characteristic;
determining a third decay rate for the third cohort with respect to participation in the particular activity by the third plurality of members, the third decay rate being determined based on the activity period for each member of the third plurality of members, the third decay rate indicating decay in participation in the particular activity in relation to the second unique data field;
identifying, as a fourth cohort, a fourth plurality of members that is associated with a fourth characteristic in response to the second query being with respect to the second unique data field, the identifying of the fourth plurality of members being based on each member of the fourth plurality of members being associated with a respective second data value of the second unique data field that satisfies the fourth characteristic;
determining a fourth decay rate for the fourth cohort with respect to participation in the particular activity by the fourth plurality of members, the fourth decay rate being determined based on the activity period for each member of the fourth plurality of members, the fourth decay rate indicating decay in participation in the particular activity in relation to the second unique data field;
modeling the third decay rate and the fourth decay rate in a cohort retention model; and
responsive to changes in the member input data, updating the cohort retention model automatically.

9. The one or more computer-readable storage media of claim 8, wherein performing the operations for determining unique data fields based on the collected member input data comprises:
comparing data of a first data field and data of a second data field of the plurality of input data fields;
determining if the data of the first data field and the data of the second data field are identical; and
responsive to determining the data of the first data field and the data of the second data field are identical, deleting the second data field.

10. The one or more computer-readable storage media of claim 9, wherein the operations further comprise:
comparing a name of the first data field and a name of the second data field; and
responsive to determining the name of the first data field and the name of the second data field are synonymous, deleting the second data field.

11. The one or more computer-readable storage media of claim 8, wherein performing the operations for determining the activity period for the each member comprises:
determining a member start date and a member end date, wherein the member end date for active members is a current date; and
calculating the activity period for the each member based on the member start date and the member end date.

12. The one or more computer-readable storage media of claim 8, wherein performing the operations for determining a first decay rate for the cohort comprises:
determining an initial number of active members in an initial activity period;
decrementing a first number of members that become inactive from the initial number of active members in the initial activity period to determine a first number of active members;
calculating a first localized decay rate between the initial activity period and the first activity period;
decrementing a second number of members that become inactive from the first number of active members in the first activity period to determine a second number of active members;
calculating a second localized decay rate between the first activity period and the second activity period; and
multiplying the first localized decay rate and the second localized decay rate to determine a first decay rate.

13. The one or more computer-readable storage media of claim 8, wherein the operations further comprise:
determining a general decay rate for the cohort, wherein the general decay rate models a decay rate for all of the member input data; and
modeling the general decay rate alongside the first decay rate, the second decay rate, the third decay rate, and the fourth decay rate.

14. A system comprising:
one or more computer-readable storage media configured to store instructions; and
one or more processors communicatively coupled to the one or more computer-readable storage media and configured to, in response to execution of the instructions, cause the system to perform operations, the operations comprising:
collecting member input data for each member of a group of subscribers of a particular activity, wherein the member input data has a plurality of input data fields in which each input data field relates to a corresponding characteristic associated with one or more of the members;
identifying a unique data field for each input data field of the plurality of input data fields to create a plurality of unique data fields;
determining an activity period for the each member;
selecting a first unique data field from the plurality of unique data fields, wherein selection of the first unique data field is in response to a user's first query being with respect to a first characteristic related to the first unique data field;
identifying, as a first cohort, a first plurality of members that is associated with the first characteristic in response to the first query being with respect to the first unique data field, the identifying of the first plurality of members being based on each member of the first plurality of members being associated with a respective first data value of the first unique data field that satisfies the first characteristic;
determining a first decay rate for the first cohort with respect to participation in the particular activity by the first plurality of members, the first decay rate being determined based on the activity period for each member of the first cohort, the first decay rate indicating decay in participation in the particular activity in relation to the first unique data field;
identifying, as a second cohort, a second plurality of members that is associated with a second characteristic in response to the first query being with respect to the first unique data field, the identifying of the second plurality of members being based on each member of the second plurality of members being associated with a respective second data value of the first unique data field that satisfies the second characteristic;
determining a second decay rate for the second cohort with respect to participation in the particular activity by the second cohort, the second decay rate being determined based on the activity period for each member of the second plurality of members, the second decay rate indicating decay in participation in the particular activity in relation to the first unique data field;
modeling the first decay rate and the second decay rate in a cohort retention model;
selecting a second unique data field from the plurality of unique data fields, wherein selection of the second unique data field is in response to a user's second query being with respect to a first characteristic related to the second unique data field;
identifying, as a third cohort, a third plurality of members that is associated with a third characteristic in response to the second query being with respect to the second unique data field, the identifying of the third plurality of members being based on each member of the third plurality of members being associated with a respective first data value of the second unique data field that satisfies the third characteristic;
determining a third decay rate for the third cohort with respect to participation in the particular activity by the third plurality of members, the third decay rate being determined based on the activity period for each member of the third plurality of members, the third decay rate indicating decay in participation in the particular activity in relation to the second unique data field;
identifying, as a fourth cohort, a fourth plurality of members that is associated with a fourth characteristic in response to the second query being with respect to the second unique data field, the identifying of the fourth plurality of members being based on each member of the fourth plurality of members being associated with a respective second data value of the second unique data field that satisfies the fourth characteristic;
determining a fourth decay rate for the fourth cohort with respect to participation in the particular activity by the fourth plurality of members, the fourth decay rate being determined based on the activity period for each member of the fourth plurality of members, the fourth decay rate indicating decay in participation in the particular activity in relation to the second unique data field;
modeling the third decay rate and the fourth decay rate in a cohort retention model; and
responsive to changes in the member input data, updating the cohort retention model automatically.

15. The system of claim 14, wherein the plurality of input data fields comprises one or more of:
member start date, member end date, use of promotions, member's industry, member demographics, and type of membership.

16. The system of claim 14, wherein determining unique data fields based on the collected member input data comprises:
comparing data of a first data field and data of a second data field of the plurality of input data fields;
determining if the data of the first data field and the data of the second data field are identical; and
responsive to determining the data of the first data field and the data of the second data field are identical, deleting the second data field.

17. The system of claim 14, further comprising:
comparing a name of the first data field and a name of the second data field; and
responsive to determining the name of the first data field and the name of the second data field are synonymous, deleting the second data field.

18. The system of claim 14, wherein determining an activity period for the each member comprises:
determining a member start date and a member end date, wherein the member end date for active members is a current date; and
calculating the activity period for the each member based on the member start date and the member end date.

19. The system of claim 14, wherein determining a first decay rate for the cohort comprises:
determining an initial number of active members in an initial activity period;
decrementing a first number of members that become inactive from the initial number of active members in the initial activity period to determine a first number of active members;
calculating a first localized decay rate between the initial activity period and the first activity period;
decrementing a second number of members that become inactive from the first number of active members in the first activity period to determine a second number of active members;
calculating a second localized decay rate between the first activity period and the second activity period; and
multiplying the first localized decay rate and the second localized decay rate to determine a first decay rate.

20. The system of claim 14, further comprising:
determining a general decay rate for the cohort, wherein the general decay rate models a decay of all of the member input data; and
modeling the general decay rate alongside the first decay rate, the second decay rate, the third decay rate, and the fourth decay rate.
